(19) United States
(12) Patent Application Publication
(10) Pub. No.: US 2026/0328628 A1
(43) Pub. Date: Oct. 22, 2026

(54) SYSTEM AND METHOD FOR MONITORING BATTERY TEMPERATURE BASED ON DUAL-SPIRAL OPTICAL FIBER SENSOR

(71) Applicant: SHANDONG UNIVERSITY, Jinan (CN)

(72) Inventors: Chenghui ZHANG, Jinan (CN); Yuhao ZHU, Jinan (CN); Yunlong SHANG, Jinan (CN); Xiaoqiang ZHANG, Jinan (CN)

(21) Appl. No.: 19/281,787

(22) Filed: Jul. 28, 2025

(30) Foreign Application Priority Data
Apr. 17, 2025 (CN) 2025104795190

(51) Int. Cl. G01K 11/32; G01K 1/143; H01M 10/44; H01M 10/46; H01M 10/48

(52) U.S. Cl. CPC G01K 11/32; G01K 1/143; H01M 10/443; H01M 10/46; H01M 10/486

(57) ABSTRACT

The present invention discloses a system for monitoring battery surface temperature based on a dual-spiral optical fiber sensor, including a dual-spiral distributed (DSD) optical fiber being arranged flat on the surface of a battery and including a first spiral structure and a second spiral structure that are opposite in winding directions; the battery is divided into a left part with center A and a right part with center B based on a center point O of the battery, respectively; with point A as spiral starting point, a starting end of DSD optical fiber spirals outward along first direction for a set number of turns, to form first spiral structure; tail end of first spiral structure transitions through point O, spirals inward along second direction for a set number of turns, and then reaches point B as terminal end of the DSD optical fiber, to form the second spiral structure.

### CROSS-REFERENCE TO RELATED APPLICATIONS

The present disclosure claims priority to Chinese Patent Application No. 202510479519.0, entitled “SYSTEM AND METHOD FOR MONITORING BATTERY SURFACE TEMPERATURE BASED ON DUAL-SPIRAL OPTICAL FIBER SENSOR” filed with the China National Intellectual Property Administration on Apr. 17, 2025, which is incorporated herein by reference in its entirety and constitutes a part of the present disclosure for all purposes.

### TECHNICAL FIELD

The present disclosure relates to the technical field of battery temperature detection, and in particular relates to a system and method for monitoring battery surface temperature based on a dual-spiral optical fiber sensor.

### BACKGROUND

The description in this section merely provides background information related to the present disclosure and does not necessarily constitute the prior art.

Lithium-ion batteries (LIBs) have high energy densities, wide operating temperature ranges, long cycle lives, and other advantages, are indispensable in an electric vehicle (EV) and an energy storage system (ESS), and also play a key role in reducing carbon dioxide emission.

Lithium-ion batteries typically require testing under various current loads and environmental conditions to quantify key parameters such as impedance and temperature. These parameters are not only the basis of laboratory experiments, but also necessary conditions for accurately evaluating the performance and safety of batteries in practical applications. Therefore, real-time temperature measurement of lithium-ion batteries is essential for maximizing performance, extending lives, and reducing risks of thermal runaway.

Traditional surface temperature measurement is typically implemented using devices such as thermocouples and thermistors, which are often fixed in predetermined positions and rely heavily on a point-based method, making it impossible to implement full-range temperature measurement. A fiber Bragg grating (FBG) sensor is a quasi-distributed optical fiber sensor, which is made by ruling Bragg gratings at specific positions on an optical fiber, and has been preliminarily used for measuring temperatures, strains, and other parameters of batteries. The prior art has disclosed use of an FBG sensor in monitoring battery temperature, and has achieved some results in state estimation, fault diagnosis, thermal runaway warning, and other aspects. However, it also faces a series of technical problems. For example,
the prior art has disclosed an optical fiber sensor monitoring apparatus and system, which implements temperature/strain monitoring at a plurality of positions by cascading a plurality of sensing units consisting of fiber gratings and Fabry-Perot cavities. However, the method has a relatively complex operation process, can only implement multi-point measurement but cannot implement full-range temperature measurement, and has high requirements for spaced arrangement of sensors.

The prior art has disclosed a method and system for monitoring batteries based on an optical fiber sensor, where a single optical fiber is allowed to sequentially pass through positive and negative tabs of each battery, thereby connecting a plurality of batteries in series. The optical fiber between the positive and negative tabs of each battery is coated with a thermosensitive or piezoelectric material, while the rest of the optical fiber is not coated. A temperature change of the battery tested may be obtained by frequency shift of the uncoated part. This solution can implement synchronous measurement of a plurality of batteries. However, for a single battery, it cannot implement full-range temperature measurement.

The prior art has disclosed a disk-type arrangement method for an optical fiber sensor, which involves winding a single optical fiber to form a disk structure attached to the surface of a battery, for monitoring temperature. However, the solution uses a single spiral (disk-shaped) arrangement and a fiber Bragg grating (FBG) sensor. Although the entire surface is covered, limited by the number of Bragg gratings and production conditions, the solution cannot implement accurate temperature measurement at any position. Also, operation and use of the FBG sensor are relatively complicated, and it needs to ensure that a gate region is not damaged. A rectangular disk-shaped arrangement of the optical fiber may cause induce excessive bending at four vertices, with a radius exceeding the maximum allowable bending radius of the optical fiber, resulting in damage or excessive loss of the optical fiber, and affecting the monitoring effect. In addition, due to limitations of temperature information and irregular arrangement, no spacing calculation and temperature mapping rules are provided, making it impossible to accurately reconstruct the distribution of a battery temperature field, which presents some limitations.

In addition, the resolution of a fiber Bragg grating sensor may have some limitations. The resolution refers to the spatial resolution of measurement of an optical fiber sensor, namely, the minimum distance between two adjacent measurement points that the sensor can distinguish. When a fiber Bragg grating sensor is used, a measurement point is a gate region, and the length of the gate region and the distance between adjacent gate regions are typically greater than specific thresholds L1 and L2. An excessively short gate region may reduce the number of optical fiber cycles, leading to insufficient Bragg reflection conditions, widened reflection peaks, and reduced resolution. The reflection intensity is correlated to the length of the gate region and a refractivity adjustment depth. An excessively short gate region may result in insufficient reflectivity and poorer signal-to-noise ratio. The length of the gate region is typically 5-10 mm, and an excessively short gate region may also increase manufacturing difficulty and reduce the performance of a sensor. Moreover, the number of gratings cannot be excessive. Each grating has a specific reflection wavelength, and in a case of a plurality of gratings, the wavelength spacing is to be large enough to avoid overlapping. When light propagates in an optical fiber, the light loses some energy after passing through each grating, and excessive gratings may cause weak signals at the distal end. Interference between a plurality of gratings may cause crosstalk, affecting the measurement accuracy.

In summary, the above methods are inherently limited to discrete or single-point measurement, or only implement continuous measurement at a plurality of points in a local region. Since the resolution of an FBG sensor cannot reach a high level, temperature information between adjacent measurement points may not be obtained, resulting in loss of features. When these features are missing, the measured temperature information is incomplete, which may lead to inaccurate analysis of temperature changes across an entire surface of a battery. Also, when a battery temperature field needs to be reconstructed, it also leads to inaccurate reconstruction results. As a result, the comprehensive analysis of thermal, mechanical and other characteristics of batteries is greatly hindered, and the effectiveness of a battery management system (BMS) in managing the performance and safety of batteries is affected.

### SUMMARY

To solve the above problems, the present disclosure provides a system and method for monitoring battery surface temperature based on a dual-spiral optical fiber sensor, where a dual-spiral sensor structure is designed, and two spiral structures are arranged near positive and negative electrodes of a battery respectively, to implement full-range temperature measurement across the surface of a battery.

In some implementations, the following technical solution is used:

A system for monitoring battery surface temperature based on a dual-spiral optical fiber sensor, includes a dual-spiral distributed optical fiber, including a first spiral structure and a second spiral structure that are opposite in winding directions; the dual-spiral distributed optical fiber being arranged flat on the surface of a battery; the battery being divided into a left part and a right part based on a center point O of the battery, and the centers of the two parts being A and B, respectively. With the point A as a spiral starting point, a starting end of the dual-spiral distributed optical fiber spiraling outward along a first direction for a set number of turns, to form the first spiral structure; and a tail end of the first spiral structure transitioning through the point O, spiraling inward along a second direction for a set number of turns, and then reaching a terminal end of the distributed optical fiber which takes the point B as a spiral end point, to form the second spiral structure.

The first spiral structure covers a positive electrode region of the surface of the battery, and the second spiral structure covers a negative electrode region of the surface of the battery.

As a further solution, a spiral spacing of the first spiral structure or the second spiral structure is specifically:

$$S = \frac{W}{2 n} + g = \frac{W}{{W}^{1 + α} / k} + g = \frac{k}{{W}^{α}} + g ,$$

wherein W is battery width, n is a number of spiral turns, g is the minimum spacing, a is an exponential coefficient that controls a nonlinear relationship between the spiral spacing S and the battery width W, typically 0<α≤1; and k is an adjustment factor.

Functional relationships between the exponential coefficient α and the adjustment factor k and the battery width W are established, respectively, as follows:

$$α = A / ( 1 + B W ) ,$$

$$k = C \cdot {W}^{D} ,$$

wherein A and C are proportionality coefficients; B is an adjustment factor for controlling a rate of decrease of α; and D is an exponential factor.

As a further solution, parameter equations for the first spiral structure are:

$$x 1 = r \times cos ( t ) ,$$

$$y 1 = r \times sin ( t ) ;$$

parameter equations for the second spiral structure are:

$$x 2 = - r \times cos ( t ) ,$$

$$y 2 = - r \times sin ( t ) ;$$

To ensure the continuity between a starting point of the second spiral structure and an end point of the first spiral structure, the coordinates of the second spiral structure are translated:

$$x {2}^{′} = x 2 + {x}_{1 end} + L ,$$

$$y {2}^{′} = y 2 + {y}_{1 end} ;$$

wherein, (x1, y1) are Cartesian coordinates of measurement points on the first spiral structure, (x2, y2) are Cartesian coordinates of measurement points on the second spiral structure, and (x2′, y2′) are Cartesian coordinates of measurement points on the translated second spiral structure; t is an angle, with a value range of [0, 2πn], and n is the number of spiral turns; r is a spiral radius, and a relationship between the spiral radius r and the angle t is: r=a+b×t; a is an initial spiral radius, and b is a rate at which the radius increases with the angle; L is a translation amount, X_{1end} is an x-coordinate of the end point of the first spiral structure, and y_{1end} is a y-coordinate of the end point of the first spiral structure.

In some other implementations, the following technical solution is used:

A method for monitoring battery surface temperature based on a dual-spiral optical fiber sensor, includes:
determining a center point O of a battery, and dividing the battery into a left part and a right part based on the center point O of the battery, the centers of the two parts being A and B, respectively;
with the point A as a spiral starting point, spiraling a starting end of the dual-spiral distributed optical fiber outward along a first direction for a set number of turns, to form a first spiral structure; transitioning a tail end of the first spiral structure through the point O, spiraling inward along a second direction for a set number of turns, and terminating at a terminal end of the distributed optical fiber which takes the point B as a spiral end point, to form a second spiral structure;
arranging a battery provided with a dual-spiral distributed optical fiber in a temperature control apparatus to provide a set temperature environment for the battery; and
charging and discharging the battery using a battery detection apparatus, interrogating the dual-spiral distributed optical fiber at regular intervals using an optical frequency domain reflectometry (OFDR) system, detecting an interference optical signal and transmitting the same to a host computer, and analyzing the interference signal by the host computer to obtain temperature information at each data point on the dual-spiral distributed optical fiber.

As a further solution, the method for monitoring battery surface temperature based on a dual-spiral optical fiber sensor further includes: mapping temperature data obtained by the dual-spiral distributed optical fiber to the surface of the battery, thereby obtaining full-range temperature change information of the surface of the battery, specifically:
establishing a plane coordinate system for the surface of the battery with the center point O of the battery as the origin; converting Cartesian coordinates of the data points on the dual-spiral distributed optical fiber to the plane coordinate system of the surface of the battery;
calculating the length of an arc between two adjacent data points on the dual-spiral distributed optical fiber, and determining an arc between two adjacent data points in the plane coordinate system; and evenly distributing data of measurement points on the optical fiber in the arc by an interpolation algorithm, to obtain full-range temperature data distribution on the surface of the battery.

As a further solution, the calculating the length of the arc between the two adjacent data points on the dual-spiral distributed optical fiber is specifically:

$$L = O ( {t}_{i + 1} ) - O ( {t}_{i} ) = {\frac{1}{b} [ \frac{a + b t}{2} \sqrt{{( a + b t )}^{2} + {b}^{2}} + \frac{{b}^{2}}{2} ln ( a + b t + \sqrt{{( a + b t )}^{2} + {b}^{2}} ) ]}_{{t}_{i}}^{{t}_{i + 1}} ,$$

wherein a is an initial spiral radius, and b is a rate at which the radius increases with the angle; t is evenly divided into m data points from 0 to 2πn, and corresponding angle values of the data points are t₀, t₁, . . . , tᵢ . . . , tₘ, respectively.

Compared with the prior art, the present disclosure has the following beneficial effects:
(1) The present disclosure designs a dual-spiral tape-type distributed optical fiber sensor structure that can optimize the arrangement of the distributed optical fiber sensor on the surface of a battery. Temperature measurement is not limited by the number of measurement points, and can obtain real-time, comprehensive, and continuous temperature data of the surface of the battery. It eliminates errors from single-point measurement caused by high-rate charging and discharging, and achieves a breakthrough from point-based to surface-based acquisition of temperature change information. The adaptability is high.

For lithium-ion pouch batteries or prismatic batteries with tabs at two ends, the temperatures are typically in gradient distribution that gradually decreases from the tabs towards the center of the batteries. Such distribution may be uneven. Especially during high-rate discharging or charging, a temperature gradient near the tabs is steeper. By a single-spiral structure disclosed in the prior art, it is difficult to implement comprehensive and continuous measurement of temperatures in the regions of tabs at two ends. The present disclosure divides the battery into the left part and the right part by the dual-spiral structure, and the spiral optical fiber is arranged at each part to monitor heat generation changes in the two parts. The left and right spirals are connected at a middle point to monitor temperature changes at the center of the battery. Temperature monitoring points can be appropriately arranged according to heat distribution of the battery, thereby comprehensively and accurately monitoring temperature changes from the two tabs to the center of the battery.
(2) The present disclosure accurately obtains a dual-spiral structure by appropriately designing spiral spacing and coordinates of each point on the spiral. Data of the optical fiber is mapped onto the surface of the battery and the temperature distribution on the surface of the battery is reconstructed. This can ensure that the temperatures at most positions on the surface can be monitored by the sensor as much as possible, to implement comprehensive monitoring on the surface of the battery. The potential temperature anomalies can be detected early and the battery design can be optimized based on the temperature distribution.
(3) An FBG sensor is used in the prior art for measuring surface temperatures of batteries. Due to limitations of the number and spacing of measurement points, the spatial resolution cannot reach a high level, which limits the ability of the sensor to obtain information. As a result, temperature information between adjacent measurement points may not be obtained, resulting in loss of features, and further resulting in incompleteness of the measured temperature information. The present disclosure achieves a fine spatial resolution using the distributed optical fiber sensor which uses continuous backscattered signals and wideband laser frequency sweeping instead of measurement at discrete points. Signals at each scattering point can be analyzed by interference to provide continuous spatial information.
(4) The dual-spiral shaped distributed optical fiber sensor structure of the present disclosure is resistant to high temperatures and corrosion, has high accuracy and fast response, and is expected to be implanted into batteries to monitor uneven temperature distribution and evolution, thereby providing corresponding support for exploring safe usage boundaries.

Other features and advantages of additional aspects of the present disclosure are partially presented in the following description, some of which become apparent from the following description, or are learned through practice of this aspect.

### BRIEF DESCRIPTION OF THE DRAWINGS

FIG. 1 shows a schematic structural diagram of arrangement of a dual-spiral distributed optical fiber on the surface of a battery in an embodiment of the present disclosure;

FIG. 2 shows a Comsol simulation result of temperature changes of a pouch battery during a charging and discharging process in an embodiment of the present disclosure;

FIG. 3 shows temperature evolution of the surface of a battery corresponding to a first spiral structure under a current of 0.5 C in an embodiment of the present disclosure;

FIG. 4 shows temperature evolution of the surface of a battery corresponding to a second spiral structure under a current of 0.5 C in an embodiment of the present disclosure;

FIG. 5 shows temperature evolution of the surface of a battery corresponding to a first spiral structure under a current of 1.0 C in an embodiment of the present disclosure; and

FIG. 6 shows temperature evolution of the surface of a battery corresponding to a second spiral structure under a current of 1.0 C in an embodiment of the present disclosure.

### DETAILED DESCRIPTION

It should be noted that the following detailed descriptions are illustrative and intended to provide further descriptions for the present application. Unless otherwise specified, all technical and scientific terms used in the present disclosure have the same meanings as those commonly understood by those skilled in the art to which the present application belongs.

It should be noted that the terms used here are only intended to describe specific embodiments and are not intended to limit exemplary embodiments according to the present application. As used here, unless otherwise explicitly stated in the context, singular form is also intended to include plural form. Furthermore, it should be understood that when the terms “comprise” and/or “comprising” are used in this specification, they indicate the presence of features, steps, operations, devices, components, and/or combinations thereof.

### Example 1

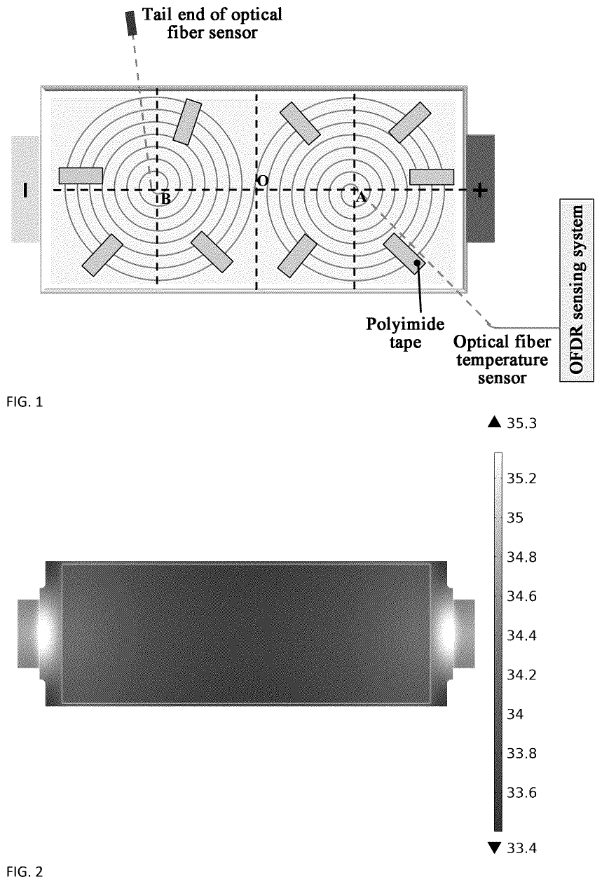

In one or more implementations, a system for monitoring battery surface temperature based on a dual-spiral optical fiber sensor is disclosed, and as shown in FIG. 1, includes a dual-spiral distributed optical fiber, including a first spiral structure and a second spiral structure that are opposite in winding directions; the dual-spiral distributed optical fiber being arranged flat on the surface of a battery, in a specific manner as follows:
the battery being divided into a left part and a right part based on a center point O of the battery, and the centers of the two parts being A and B, respectively; with the point A as a spiral starting point, a starting end of the dual-spiral distributed optical fiber spiraling outward along a first direction for a set number of turns, to form the first spiral structure; and a tail end of the first spiral structure transitioning through the point O, spiraling inward along a second direction for a set number of turns, and then reaching a terminal end of the distributed optical fiber which takes the point B as a spiral end point, to form the second spiral structure.

As a specific example, the present example selects a distributed optical fiber sensor based on Rayleigh scattering. An optical fiber with a core diameter of 9 μm and a cladding diameter of 125 μm is selected. The surface of the optical fiber is coated with polyimide by a dip coating, spray coating, or spin coating process to ensure uniform coating with moderate thickness (typically several micrometers to tens of micrometers). After coating, the polyimide coating is hardened by high-temperature curing (typically at 200° C. to 300° C.) to form a protective layer. Then the optical fiber is fixed in a soluble polytetrafluoroethylene (PFA) or polyimide (PI) sleeve, to reduce or completely block, by a physical design, an external mechanical stress from being transferred to an optical fiber core. Therefore, changes in Rayleigh scattering signals mainly reflect temperature effects rather than strain effects, and strains are prevented from affecting temperatures.

The sleeve is typically a flexible or rigid protective layer (e.g., a polymer sleeve, a stainless steel tube, or a relaxed structure) that wraps the sensing optical fiber inside. The optical fiber maintains a controlled degree of freedom inside the sleeve and is not directly closely coupled with an external structure. The sleeve absorbs or disperses external tensile, compressive, or bending stresses, preventing these forces from directly acting on the optical fiber. In this design, when mechanical deformation (e.g., tension or compression) occurs in an external environment, the sleeve may bear these stresses first while the optical fiber is in a relaxed state and experiences no tension or compression. Therefore, the length and strain state of the optical fiber remain basically unchanged, making signal changes only caused by temperatures, and ensuring the accuracy of temperature measurement results.

The first spiral structure is arranged near a positive electrode of the battery, covers a positive electrode region of the surface of the battery, and spirals counterclockwise. The second spiral structure is arranged near a negative electrode of the battery, covers a negative electrode region of the surface of the battery, and spirals clockwise.

The first spiral structure and the second spiral structure can completely cover all regions of the surface of the battery to implement full-range measurement of surface temperatures of the battery.

For a lithium-ion pouch or prismatic battery with positive and negative tabs at two ends, the distribution of a temperature field is a complex issue of heat conduction and heat generation during charging and discharging processes, and is affected by various factors including charging and discharging rates of the battery, the material and design of the tabs, an ambient temperature, and heat conduction characteristics of an internal structure of the battery. FIG. 2 shows a Comsol simulation result of temperature changes in a pouch battery.

After investigation and further research, it is found that:
(1) As conductive connection points between positive and negative electrodes of a battery, tabs generate Joule heat (i.e., resistance heat) during charging and discharging processes due to passage of current. Tabs are typically made of metals (e.g., aluminum commonly used for a positive electrode and nickel or nickel plated copper commonly used for a negative electrode). Although the resistance of the metals is low, the metals have significant heat accumulation at a high current density during high-rate charging and discharging. Therefore, the tabs and surrounding regions thereof are often local high-temperature regions on the surface of a battery and inside the battery.
(2) When tabs are arranged at two ends of a battery, the heat is mainly transferred from the tabs at the two ends to the center of the battery. Due to a typically used layered structure (e.g., wound or stacked), the heat transfer along an axial direction of the tab and a direction perpendicular to the tab may exhibit differences: the temperature near a tab region is the highest because a heat source is concentrated here, and there may be additional contact resistance when the tab is connected to an external circuit, further promoting heat generation. The temperature in the middle of the battery is relatively low because the heat is transferred through a material inside a battery cell (e.g., an electrode, a separator, and an electrolyte), and the thermal conductivity of these materials is typically low, resulting in a low heat transfer efficiency. The temperatures are typically in gradient distribution that gradually decreases from the tabs towards the center of the battery typically. Such distribution may be uneven. Especially during high-rate discharging or charging, a temperature gradient near the tabs is steeper.

Based on the above reasons, the present example uses the dual-spiral structure shown in FIG. 1, to comprehensively and accurately monitor temperature changes of the battery from the tabs to the center. The battery is divided into the left part and the right part, and the spiral optical fiber is arranged at each part to monitor heat generation changes. The left and right spirals are connected at a middle point to monitor temperature changes at the center of the battery.

Specifically, the first spiral structure and the second spiral structure are arranged as follows:
(1) A spiral spacing of the first spiral structure or the second spiral structure is calculated specifically as:

$$S = \frac{W}{2 n} + g = \frac{W}{{W}^{1 + α} / k} + g = \frac{k}{{W}^{α}} + g ,$$

wherein, W is battery width, n is a number of spiral turns, g is the minimum spacing, α is an exponential coefficient that controls a nonlinear relationship between the spiral spacing S and the battery width W, typically 0<α≤1; and k is an adjustment factor.

In the above parameters, the minimum spacing g is set to ensure that the spiral spacing S does not approach 0, especially when the battery width W is very large. If g=0, there is no lower limit, and S may approach 0, resulting in an excessive number of turns. g>0 can ensure the visibility of the spiral or meet practical application requirements. The range of the minimum spacing g in the present example is [0.1-1], depending on the battery width W and the specific application scenario. As a specific example, the width W of the pouch battery is 9.9 cm, and the minimum spacing g is set to 0.3 cm to ensure that the spacing has practical significance.

The exponential coefficient α is used for controlling a rate at which the spiral spacing S varies with the battery width W. When α=0, the requirement is not satisfied; when α=1, they are in a strict inverse relationship, and S decreases rapidly; and when 0<α<1, they are in a mild inverse relationship, and S decreases relatively gently.

The adjustment factor k is used for controlling the absolute magnitude of the spiral spacing S. The larger the k, the larger the S, and the smaller the number of spiral turns n (which decreases). If the battery width W is 1-100, and α=0.5, then k=5-20 is a reasonable starting point, and k=10 is a compromise value that can generate a large S at a small W and maintain a reasonable S at a large W.

In the present example, it is preferred that α and k can be adaptively adjusted according to the battery width W, rather than being fixed values, to obtain reasonable spiral spacings S and numbers of turns n at different widths. Therefore, a dynamic adjustment mechanism is introduced to make α and k functions of W, specifically as follows:

$$α = A / ( 1 + B W ) ,$$

$$k = C \cdot {W}^{D} ,$$

wherein, A is a proportionality coefficient, which is also the maximum α value; the value range of A is 0.5<A<1.5; when A<0.5, α is too small and a decrease in S is not significant enough; and when A>1.5, α is too large, S decreases too quickly, and the number of turns n may be too small. In the present example, A=1 is selected, which is simple and effective, and a gradually decreases from 1.

B is an adjustment factor used for controlling the rate of decrease in α. The larger the B, the faster the decrease in α. The smaller the B, the slower the decrease in α. When W=0, α=A. When W is very large, α→0. A reasonable range of B may be [0.01, 0.2]. When B<0.01, α hardly changes with W and loses adaptability. When B>0.2, α decreases too quickly, and S is too small at a high W. In the present example, the value of B is [0.05, 0.1], and the rate is moderate and suitable for a medium width range.

C is a proportionality coefficient that determines the absolute magnitude of k and directly affects the value of S. The larger the C, the larger the S, and the smaller the number of turns n. A reasonable range of C may be 2-10. When C<2, S is too small and the number of turns n may be excessive. When C>10, S may be too large and n may be less than 1. In the present example, the value of C is [3, 7], balancing S and the number of turns n.

D is an exponential, and 0<D<1, which causes k to slowly increase with W and prevents S from decreasing too quickly. A reasonable range of D may be 0.3-0.7. It is recommended that D=0.5, which is simple and has a smooth effect.
(2) Parameter equations for the first spiral structure and the second spiral structure are calculated.

Parameter equations for the first spiral structure are:

$$x 1 = r \times cos ( t ) ,$$

$$y 1 = r \times sin ( t ) ;$$

parameter equations for the second spiral structure are:

$$x 2 = - r \times cos ( t ) ,$$

$$y 2 = - r \times sin ( t ) ;$$

To ensure the continuity between a starting point of the second spiral structure and an end point of the first spiral structure, the coordinates of the second spiral structure are translated:

$$x {2}^{′} = x 2 + {x}_{1 end} + L ,$$

$$y {2}^{′} = y 2 + {y}_{1 end} ,$$

wherein, (x1, y1) are Cartesian coordinates of measurement points on the first spiral structure, (x2, y2) are Cartesian coordinates of measurement points on the second spiral structure, and (x2′, y2′) are Cartesian coordinates of measurement points on the translated second spiral structure; t is an angle, with α value range of [0, 2πn], the t-values vary at different points of positions, and n is the number of spiral turns; for example, if it is desired that the number of spiral turns is 4, then n is set to 4, which means four revolutions;
r is a spiral radius, and a relationship between the spiral radius r and the angle t is: r=a+b×t; a is an initial spiral radius, and b is a rate at which the radius increases with the angle; x_{1end} is an x-coordinate of the end point of the first spiral structure, and y_{1end} is a y-coordinate of the end point of the first spiral structure; L is a translation amount, and actually, is a radius value of the first spiral at parameter t=2π×n, namely:

$$L = a + 2 π bn .$$

Assuming a=1 and b=0.5, then r=1+0.5t. When n is 4 (i.e., 4 revolutions), then:

$$L = 1 + 4 π \approx 13.5664 .$$

The translation amount L may be used to ensure that the terminal end of the second spiral aligns precisely with the end point of the first spiral after translation, thus forming a continuous dual-spiral curve.

As the angle t increases linearly, the spiral gradually expands outward, resulting in a first spiral curve that starts from the origin and gradually increases in radius. When t=0, r=1, (x1, y1)=(1, 0), and the starting point is in a positive direction of the x-axis. As t increases and r increases, cos(t) and sin(t) cause a point to move along the circumference, forming an outward expanding spiral.

The second spiral structure is a spiral that is symmetrical to the first spiral structure, achieving a mirror effect by inversion about the x-axis. Namely, the second spiral structure and the first spiral structure are the same in shapes but opposite in directions.

Coordinates of points at different positions on the first spiral structure and the second spiral structure can be obtained in the above manner and combined with the spiral spacing, a specific arrangement manner of the first spiral structure and the second spiral structure can be determined.

After the arrangement manner of the first spiral structure and the second spiral structure is determined, temperature data obtained by the dual-spiral distributed optical fiber may be further mapped to the surface of the battery by a spatial mapping algorithm, thereby obtaining full-range temperature change information of the surface of the battery. A specific process is as follows:
a plane coordinate system for the surface of the battery is established with the center point O of the battery as the origin; Cartesian coordinates of the data points on the dual-spiral distributed optical fiber are converted to the plane coordinate system of the surface of the battery;
the length of an arc between two adjacent data points on the dual-spiral distributed optical fiber is calculated, and an arc between two adjacent data points in the plane coordinate system is determined; and data of measurement points on the optical fiber in the arc is evenly distributed by an interpolation algorithm, thus each data point in the dual-spiral structure and a corresponding arc between every two data points are accurately mapped to the surface of the battery, and the distribution of the dual-spiral structure on the surface of the battery is obtained, thereby obtaining full-range temperature data distribution on the surface of the battery.

Specifically, the length of an arc between the two adjacent data points on the dual-spiral distributed optical fiber is calculated as follows:

$$L = O ( {t}_{i + 1} ) - O ( {t}_{i} ) = {\frac{1}{b} [ \frac{a + b t}{2} \sqrt{{( a + b t )}^{2} + {b}^{2}} + \frac{{b}^{2}}{2} ln ( a + b t + \sqrt{{( a + b t )}^{2} + {b}^{2}} ) ]}_{{t}_{i}}^{{t}_{i + 1}} ,$$

wherein, a is an initial spiral radius, and b is a rate at which the radius increases with the angle. In Matlab, t may be evenly divided into m data points from 0 to 2πn by a Linspace function, and corresponding angle values of the data points are t₀, t₁, . . . , tᵢ . . . , tₘ, respectively.

Assuming that t is evenly distributed (points may be evenly distributed by the Linspace function in Matlab), then:

$${t}_{i} = \frac{i - 1}{1999} \times 8 π , i = 1 , 2 , … , 2000 ,$$

thus, the difference between adjacent points is:

$$Δ t = \frac{8 π}{1999} ,$$

t-value pairs of the adjacent points are (tᵢ, tᵢ₊₁), e.g., (t₁, t₂), (t₂, t₃), . . . , (t₁₉₉₉, t₂₀₀₀).

The arc length between each pair of adjacent points may be calculated by formula L. For example, when a=1 and b=0.5, the arc length Lᵢ between each pair of points may be calculated. If t₁=0 and t₂=8π/1999, the arc length between the two adjacent points is calculated as 0.013. Due to the even distribution of t, Δt between adjacent points is fixed. However, since r(t)=a+bt is linear, an arc length differential element [(a+bt)²+b²]^{1/2} may increase with t, and the arc length between adjacent points may gradually increase.

In actual situations, specific values such as n/4 or n/2 may be used as intervals for calculation, which may reduce the computational complexity.

Based on the distribution of the dual-spiral structure on the surface of the battery, the distributed optical fiber is arranged flat on the surface of the battery, with careful handling during operation to avoid the damage to the sensor.

In some implementations, since a PFA or PI sleeve is arranged outside the optical fiber, for ease of operation, the optical fiber may be stuck to the surface of the battery directly using an epoxy resin adhesive. After sticking, secondary fixation is performed using PI tape to prevent the sensor from falling off or being damaged due to other uncertain factors.

In some other implementations, a flexible film substrate is designed based on the size of the battery, grooves adapted to the dual-spiral distributed optical fiber are cut in the substrate by laser, and the dual-spiral distributed optical fiber is embedded in the grooves, fixed with a UV curing adhesive, laid flat on the surface of the battery, and fixed with PI tape.

By either of the above two implementations, the dual-spiral distributed optical fiber sensor may be fixed to the surface of the battery, forming a dual-spiral tape-type temperature sensor arrangement.

After the sensor is arranged, the surface of the battery is wiped and cleaned with anhydrous ethanol. The starting and ending points of the sensor are positioned using a refrigerant. The terminal end of the optical fiber is generally knotted to reduce the reflection loss. In the present example, the spatial resolution of the sensor is set to 1.28 mm, which means that a measurement point is set every 1.28 mm to obtain temperature change information.

As a further implementation, the system for monitoring battery surface temperature based on a dual-spiral optical fiber sensor further includes: a temperature control apparatus, a battery detection apparatus, an OFDR system, and a host computer.

A battery provided with a dual-spiral tape-type temperature sensor is arranged in the temperature control apparatus, and the temperature control apparatus can provide a stable temperature environment desired by the battery.

In the present example, the temperature control apparatus is a temperature-controlled chamber that can maintain a constant temperature. The battery detection apparatus is a charging and discharging tester connected to the host computer, and can execute a control configuration file of the host computer to charge and discharge the battery, while collecting relevant electrical signal data. The OFDR system is connected to the host computer. The OFDR system interrogates the dual-spiral distributed optical fiber at regular intervals, detects an interference optical signal, and extracts distributed temperature information and transmits the same to the host computer, thereby obtaining full-range temperature change information of the surface of the battery.

Specifically, a battery to be tested is placed in the temperature-controlled chamber, and positive and negative electrodes of the battery are connected to a signal wire and a test wire of the charging and discharging tester. The battery is charged and discharged via testing software in the host computer. In the charging and discharging process of battery, the surface temperature changes. The optical fiber sensor is affected by the temperature, resulting in frequency shift of an interference optical signal. The frequency shift is detected by a photodetector (PD), and then analyzed and processed in a data processing unit (DPU) to extract distributed temperature information.

In the present example, the OFDR system typically includes: a tunable laser source (TLS), an optical coupler (OC), an interferometer, a photodetector (PD), and a data processing unit (DPU). The tunable laser source emits an optical signal with linearly tuned frequency, and the optical coupler divides the optical signal into two paths: one is injected into an optical fiber to be detected, and the other is used as a reference optical path. When the optical signal propagates in the optical fiber to be detected, a reflection signal is generated due to the effects of Rayleigh scattering, Fresnel reflection, and the like. The reflection signal interferes with a reference optical path signal in the interferometer, generating an interference signal.

When the temperature applied to the optical fiber changes, an effective refractive index and an effective length of the optical fiber also change, resulting in a shift in a Rayleigh scattering wavelength inside the optical fiber. This relationship may be expressed as:

$$Δ λ / {λ}_{0} = {K}_{T} Δ T + {K}_{ε} Δ ε ,$$

wherein, K_{T}=α+ζ, K_{ε}=1−pₑ are a temperature sensitivity coefficient and a strain sensitivity coefficient, respectively; α is a coefficient of thermal expansion, ζ is a thermal optical coefficient, and pₑ is a photoelastic coefficient.

Δλ typically refers to a shift of the spectral frequency of a backscattered light relative to a reference state. λ₀ refers to a nominal operating wavelength of the laser source, typically 1550 nm, corresponding to a frequency of approximately 193.5 THz, which is the most commonly used low-loss wavelength window in optical signal communication and optical fiber sensing. In the OFDR system, the laser may perform linear frequency sweep around the central wavelength, with a swept frequency range of several tens of GHz to several THz. For example, if the central wavelength of the laser is 1550 nm, the swept frequency range may be 1549-1551 nm, corresponding to a frequency variation of ±193.5 GHZ.

Δε represents a strain change. Position information is embodied by a measurement principle of OFDR. OFDR uses a linearly tunable laser to emit an optical signal, and a Rayleigh scattering signal in the optical fiber is reflected back and interferes with a reference light. By analyzing the frequency of the interference signal, the position of a scattering point can be determined. In OFDR, the frequency of the laser source varies linearly at a specific sweep rate (in Hz/s). Optical signals reflected back from scattering points at different positions in the optical fiber may have different time delays (t), corresponding to different interference frequencies (f).

A formula for a relationship between the interference frequency and the position is:

$$f = ( 2 n / c ) * sweep\_rate * z ,$$

wherein, f is the frequency (in Hz) of the interference signal, n is a refractive index of the optical fiber, c is speed of light (about 3×10⁸ m/s), sweep_rate is a laser frequency sweep rate (in Hz/s), and z is a position in the optical fiber (in m).

By performing Fourier transform on the interference signal, the frequency f may be mapped to the position z, thereby obtaining temperature change information corresponding to different positions of the optical fiber.

The present example achieves a fine spatial resolution using the distributed optical fiber sensor which uses continuous backscattered signals and wideband laser frequency sweeping instead of measurement at discrete points. A formula for the spatial resolution is as follows:

$$Δ z = c / 2 \cdot {n}_{eff} \cdot Δ F ,$$

wherein, c is speed of light, n_{eff} is a refractive index of the optical fiber, and ΔF is a laser swept frequency range. The larger the ΔF, the higher the resolution. Rayleigh scattering is generated by natural refractive index fluctuations in the optical fiber and is continuously distributed along the optical fiber. OFDR provides continuous spatial information by analyzing a signal of each scattering point through interference.

Unlike fiber Bragg grating (FBG) that relies on discrete gate regions, distributed sensing does not require a prefabricated structure and theoretically has no fixed point limitations on resolution.

The present example uses a pouch battery produced by a company to verify the feasibility and effectiveness of the method according to the present example. A nickel cobalt manganese (NCM) battery has a rated capacity of 80.7 Ah, a voltage range of 2.8-4.25 V, and a maximum charging/discharging current of 193.7 A (2.4 C)/161 A (2 C). Parameter specifications of the battery are shown in Table 1.

TABLE 1

| | | Rated | Voltage | Maximum | Maximum |
|---|---|---|---|---|---|
| | | capacity | range | charging | discharging |
| Size (mm) | Material | (Ah) | (V) | current (A) | current (A) |
| 354*99*12.6 | Positive electrode: | 80.7 | 2.8-4.25 | 193.7 (2.4 C) | 161 (2 C) |
| | NCM | | | | |
| | Negative electrode: | | | | |
| | Graphite | | | | |

The dual-spiral distributed optical fiber according to the present example is arranged on the pouch battery, and temperature testing is performed using the system for monitoring battery surface temperature based on a dual-spiral optical fiber sensor according to the present example. All experiments are conducted in a constant temperature environment of 25° C. Before current loading begins, the battery is initially allowed to rest for 180 min to reach thermal equilibrium. A constant current-constant voltage (CC-CV) protocol is used for charging the battery. The charging rates are 0.5 C and 1 C, respectively. In a CC stage, the battery is charged to a cut-off voltage of 4.2 V. Then, a charging mode is switched to constant voltage (CV) until the current drops to C/20. Next, the battery cell is allowed to stand for 180 min. At each discharging stage, the current rate remains constant and consistent with the charging stage. The discharging ends when the voltage drops to 2.8 V. Before a next charging and discharging cycle at a higher rate begins, the battery still needs to rest for 180 min.

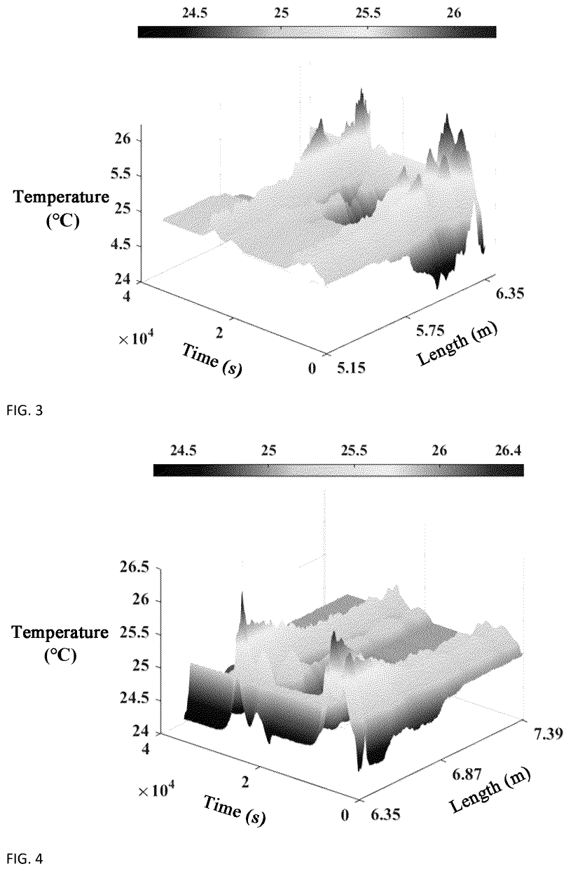

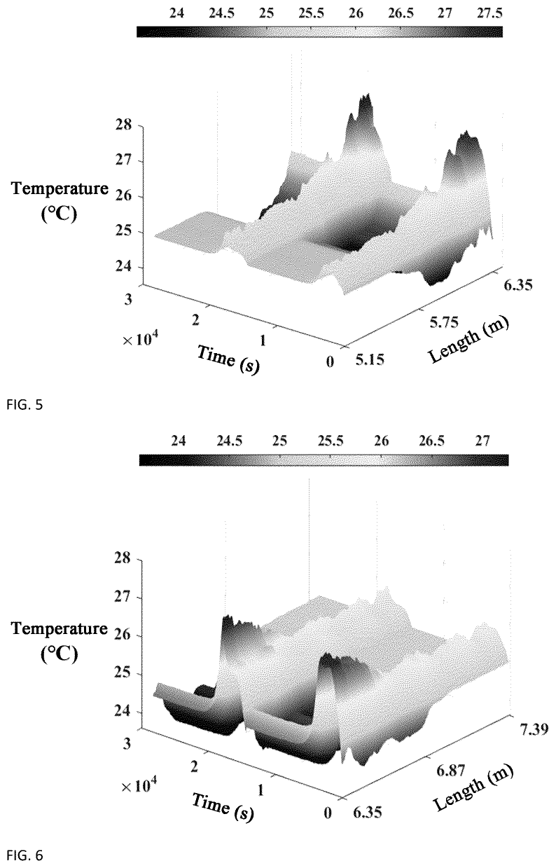

FIG. 3 to FIG. 6 show temperature evolution results of the surface of the battery at the current rates of 0.5 C and 1 C, respectively. Each rate includes temperature changes of the first spiral structure and the second spiral structure, respectively. An x-axis represents the length of an optical fiber, a y-axis represents the charging and discharging time, and a z-axis represents the surface temperature. It can be seen from the figures that the method according to the present example can implement full-range temperature monitoring on the surface of the battery, and the temperatures at all points on the surface of the battery exhibit high inconsistency and anisotropy. Compared with other positions, temperature changes are more significant near the center and positive and negative electrodes of the battery during the charging and discharging process.

The optical fiber temperature sensor used in the present example is coated with a polyimide layer on the surface and encapsulated with a PFA loose sleeve. The allowable working temperature is −60° C. to 300° C., enabling full-range temperature monitoring. The dual-spiral arrangement structure ensures temperature monitoring radiates outward from different center points of the battery. Taking FIG. 3 and FIG. 4 as examples, the horizontal axis represents the charging and discharging time, and the vertical axis represents the length of the optical fiber arranged along the surface of the battery. It can be seen that temperature changes can be monitored at any position along the entire optical fiber, enabling all-round monitoring.

The present example uses the distributed optical fiber sensor to monitor the temperature changes, which can implement temperature measurement at any position along one optical fiber with a high spatial resolution. Compared with traditional optical fiber Bragg grating sensors, the number of measurement points has an exponential increase, and more temperature change information of the surface of the battery are obtained while accuracy is ensured, without being limited by the number of gratings. In addition, the method obtains sufficient temperature information, which helps to reconstruct the distribution of a surface temperature field of the battery in the future and further supports the thermal management of the battery.

Although specific implementations of the present disclosure are described above in conjunction with the accompanying drawings, the implementations do not limit the scope of protection of the present disclosure. Those skilled in the art should understand that various modifications or variations that can be made by those skilled in the art without creative labor based on the technical solution of the present disclosure are still within the scope of protection of the present disclosure.

1. A system for monitoring battery surface temperature based on a dual-spiral optical fiber sensor, comprising: a dual-spiral distributed optical fiber, comprising a first spiral structure and a second spiral structure that are opposite in winding directions; the dual-spiral distributed optical fiber being arranged flat on the surface of a battery; the battery being divided into a left part and a right part based on a center point O of the battery, and the centers of the two parts being A and B, respectively; with the point A as a spiral starting point, a starting end of the dual-spiral distributed optical fiber spiraling outward along a first direction for a set number of turns, to form the first spiral structure; a tail end of the first spiral structure transitioning through the point O, spiraling inward along a second direction for a set number of turns, and then reaching a terminal end of the distributed optical fiber which takes the point B as a spiral end point, to form the second spiral structure;
a spiral spacing of the first spiral structure or the second spiral structure being specifically:
$$S = \frac{W}{2 n} + g = \frac{W}{{W}^{1 + α} / k} + g = \frac{k}{{W}^{α}} + g ,$$
wherein, W is battery width, n is a number of spiral turns, g is the minimum spacing, a is an exponential coefficient that controls a nonlinear relationship between the spiral spacing S and the battery width W, 0<α≤1; and k is an adjustment factor;
parameter equations for the first spiral structure being:
$$x 1 = r \times cos ( t ) ,$$
$$y 1 = r \times sin ( t ) ;$$
parameter equations for the second spiral structure being:
$$x 2 = - r \times cos ( t ) ,$$
$$y 2 = - r \times sin ( t ) ;$$
to ensure the continuity between a starting point of the second spiral structure and an end point of the first spiral structure, the coordinates of the second spiral structure being translated:
$$x {2}^{′} = x 2 + {x}_{1 end} + L ,$$
$$y {2}^{′} = y 2 + {y}_{1 end} ,$$
wherein (x1, y1) are Cartesian coordinates of measurement points on the first spiral structure, (x2, y2) are Cartesian coordinates of measurement points on the second spiral structure, and (x2′, y2′) are Cartesian coordinates of measurement points on the translated second spiral structure; t is an angle, with α value range of [0, 2πn]; r is a spiral radius, and a relationship between the spiral radius r and the angle t is: r=a+b x t; a is an initial spiral radius, and b is a rate at which the radius increases with the angle; L is a translation amount, x_{1end} is an x-coordinate of the end point of the first spiral structure, and y_{1end} is a y-coordinate of the end point of the first spiral structure.

2. The system for monitoring battery surface temperature based on a dual-spiral optical fiber sensor according to claim 1, wherein the surface of the dual-spiral distributed optical fiber is coated with polyimide, and the distributed optical fiber coated with the polyimide is fixed in a soluble polytetrafluoroethylene or polyimide sleeve.

3. The system for monitoring battery surface temperature based on a dual-spiral optical fiber sensor according to claim 1, wherein the first spiral structure covers a positive electrode region of the surface of the battery, and the second spiral structure covers a negative electrode region of the surface of the battery.

4. The system for monitoring battery surface temperature based on a dual-spiral optical fiber sensor according to claim 1, further comprising: a temperature control apparatus, a battery detection apparatus, an OFDR system, and a host computer, a battery provided with a dual-spiral optical fiber sensor being arranged in the temperature control apparatus; the battery being charged and discharged via the battery detection apparatus; and the OFDR system interrogating the dual-spiral distributed optical fiber at regular intervals, and detecting and analyzing an interference optical signal to obtain temperature change information at different positions and transmit the same to the host computer, thereby extracting full-range temperature change information of the surface of the battery.

5. The system for monitoring battery surface temperature based on a dual-spiral optical fiber sensor according to claim 1, wherein functional relationships between the exponential coefficient α and the adjustment factor k and the battery width W are established, respectively, as follows:
$$α = A / ( 1 + B W ) ,$$
$$k = C \cdot {W}^{D} ,$$
wherein A and C are proportionality coefficients; B is an adjustment factor for controlling a rate of decrease of α; and D is an exponential factor.

6. A method for monitoring battery surface temperature of the system for monitoring battery surface temperature based on a dual-spiral optical fiber sensor according to claim 1, comprising:
determining a center point O of a battery, and dividing the battery into a left part and a right part based on the center point O of the battery, the centers of the two parts being A and B, respectively;
with the point A as a spiral starting point, spiraling a starting end of the dual-spiral distributed optical fiber outward along a first direction for a set number of turns, to form a first spiral structure; transitioning a tail end of the first spiral structure through the point O, spiraling inward along a second direction for a set number of turns, and terminating at a terminal end of the distributed optical fiber which takes the point B as a spiral end point, to form a second spiral structure;
arranging a battery provided with a dual-spiral distributed optical fiber in a temperature control apparatus to provide a set temperature environment for the battery; and
charging and discharging the battery using a battery detection apparatus, interrogating the dual-spiral distributed optical fiber at regular intervals using an OFDR system, detecting an interference optical signal and transmitting the same to a host computer, and analyzing the interference signal by the host computer to obtain temperature information at each data point on the dual-spiral distributed optical fiber.

7. The method for monitoring battery surface temperature according to claim 6, further comprising: mapping temperature data obtained by the dual-spiral distributed optical fiber to the surface of the battery, thereby obtaining full-range temperature change information of the surface of the battery, specifically:
establishing a plane coordinate system for the surface of the battery with the center point O of the battery as the origin; converting Cartesian coordinates of the data points on the dual-spiral distributed optical fiber to the plane coordinate system of the surface of the battery;
calculating the length of an arc between two adjacent data points on the dual-spiral distributed optical fiber, and determining an arc between two adjacent data points in the plane coordinate system; and evenly distributing data of measurement points on the optical fiber in the arc by an interpolation algorithm, to obtain full-range temperature data distribution on the surface of the battery.

8. The method for monitoring battery surface temperature according to claim 7, wherein the calculating the length of an arc between two adjacent data points on the dual-spiral distributed optical fiber is specifically:
$$L = O ( {t}_{i + 1} ) - O ( {t}_{i} ) = {\frac{1}{b} [ \frac{a + b t}{2} \sqrt{{( a + b t )}^{2} + {b}^{2}} + \frac{{b}^{2}}{2} ln ( a + b t + \sqrt{{( a + b t )}^{2} + {b}^{2}} ) ]}_{{t}_{i}}^{{t}_{i + 1}} ,$$
wherein a is an initial spiral radius, and b is a rate at which the radius increases with the angle; t is evenly divided into m data points from 0 to 2πn, and corresponding angle values of the data points are t₀, t₁, . . . , tᵢ . . . , tₘ, respectively.
